(19) United States
(12) Patent Application Publication
(10) Pub. No.: US 2019/0344714 A1
(43) Pub. Date: Nov. 14, 2019

(54) LANE CHANGER WARNING SYSTEM AND METHOD OF THE SAME

(71) Applicant: DENSO CORPORATION, Kariya-city (JP)

(72) Inventors: Jie Shen, Shanghai (CN); Min Shao, Shanghai (CN)

(21) Appl. No.: 16/398,389

(22) Filed: Apr. 30, 2019

(30) Foreign Application Priority Data
May 9, 2018 (CN) 201810436357.2

(51) Int. Cl. B60Q 9/00; B60W 30/095; B60W 50/14; B60W 50/00

(52) U.S. Cl. CPC B60Q 9/008; B60W 30/0953; B60W 50/14; B60W 2550/302; B60W 2050/143; B60W 2550/308; B60W 2550/306; B60W 50/0097

(57) ABSTRACT

This disclosure provides a lane changer warning system and a lane changer warning method. The system has a detector and a control device. The detector is disposed on an own vehicle, and measures a relative distance between the own vehicle and other vehicles located surroundings of the own vehicle. The control device performs process of determining a lane change of the other vehicle approaching from behind based on a detection data from the detector. The lane changer determination is performed based on a real-time detection and data analysis about other vehicles behaviors and road environment change. The notification device issues, to a driver of the own vehicle by appropriate means, warning of an existence of a lane changing vehicle which is likely to merge into a lane where the own vehicle is traveling from behind by intentionally changes the lane.

### CROSS REFERENCE TO RELATED APPLICATION

The present application claims the benefit of priority from China Patent Application No. 201810436357.2 filed on May 9, 2018. The entire disclosures of all of the above application are incorporated herein by reference.

### TECHNICAL FIELD

The present disclosure relates to a system of warning a lane changer and a method of the same.

### BACKGROUND ART

In the present market, there are safe driving assistance systems.

### SUMMARY

It is an object of the present disclosure to provide a system of warning a lane changer and a method of warning a lane changer.

It is another object of the present disclosure to provide a system of warning a lane changer and a method of warning a lane changer prior to a completion of a lane change of another vehicle.

The disclosed lane changer warning system comprises a detector and a control device. The detector measures relative distances between the own vehicle and other vehicles around the vehicle. The control device computes, by at least one processor, a lane change of another vehicle traveling from behind.

The lane changer warning system of above structure may computes a lane change of the other vehicle traveling from behind based on the detection data of the detector.

The disclosed lane changer warning method comprises the steps of, performed by at least one processor, a detecting step, and a computing step. In the detecting step, relative distances between an own vehicle and other vehicles around the own vehicle is measured by using a detector disposed on the own vehicle. The computing step performs a lane changer calculation of other vehicles traveling from behind by using the control device based on detected data in the detecting step.

### BRIEF DESCRIPTION OF DRAWINGS

FIG. 1 is a schematic structural diagram showing a lane changer warning system according to an embodiment,

FIG. 2 is a schematic diagram showing the operation principle of the lane changer warning system in the embodiment,

FIG. 3 is a schematic diagram showing the operation principle of the lane changer warning system in the embodiment,

FIG. 4 is a flowchart showing process of the lane changer warning system in the embodiment,

FIG. 5 is a flowchart showing process of the lane changer warning system in the embodiment, and

FIGS. 6A, 6B, 6C, 6D, 6E and 6F are schematic diagrams showing process of cases of the lane changer warning system in the embodiment.

### DETAILED DESCRIPTION

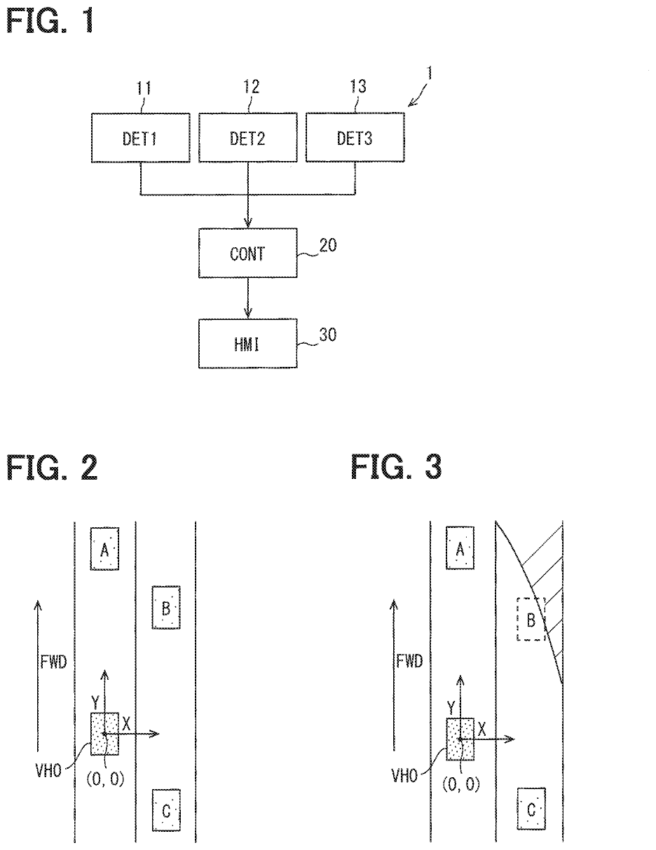

Hereinafter, a lane changer warning system according to an embodiment is described with reference to FIGS. 1 to 5.

FIG. 1 is a schematic structural diagram showing a lane changer warning system according to an embodiment. As shown in FIG. 1, the lane changer warning system 1 mainly includes a detector 10 (DET1, DET2, DET3), a control device 20 (CONT), and a notification device 30 (HMI). The detector 10 is a sensor, radar, or the like provided in the vehicle. The detector 10 is used to measure a relative distance between an own vehicle and other vehicles around the own vehicle. In the following description, the own vehicle may be simply referred to as the vehicle. The detector 10 has, for example, a plurality of detectors. The detector 10 has a first detector 11 which is disposed on a front of the vehicle, a second detector 12 which is disposed on a rear of the vehicle, and a third detector 13 which is disposed on a side of the vehicle. The notification device 30 may be provided by a human machine interface functions as the interfaces between people (users) and computers.

The control device 20 computes, by at least one processor, a possibility of lane change of another vehicle traveling from behind based on the detection data of the detector 10. The computing the lane change is a computing process to estimate a possibility of a lane change maneuver of the other vehicle traveling and approaching from behind to merge into a lane in front of the own vehicle. This estimation process is also referred to as a lane changer computing control about another vehicle approaching from behind. The computation by the control device 20 includes computing of a rapid approach of the other vehicle traveling from behind and computing of a lane change of the other vehicle traveling from behind.

When the computing result of the control device 20 is a rapid approach, the notification device 30 gives a warning of the rapid approach of the other vehicle traveling from behind. In a preferred embodiment, the notification device 30 issues the warning at an initial stage of the rapid approach period, that is, issues the warning prior to a lane change that may subsequently occur after the raid approach. When the computing result of the control device 20 is a situation showing a possible lane change of the other vehicle traveling from behind, the notification device 30 gives a warning of the possible lane change of the other vehicle traveling from behind. In a preferred embodiment, the notification device 30 issues the warning at an initial stage of a lane change action period, that is, issues the warning prior to a completion of a lane change.

The control device in this specification may be sometimes referred to as an electronic control unit (ECU: Electronic Control Unit). The control device or the control system is provided by (a) an algorithm as a plurality of logic called an if-then-else form, or (b) a learned model tuned by machine learning, e.g., an algorithm as a neural network. The control device is provided by a control system including at least one computer. The control system may include a plurality of computers linked by a data communication device. The computer includes at least one processor (hardware processor) that is hardware. The hardware processor may be provided by (i), (ii), or (iii) below.(i) The hardware processor may be at least one processor core executing a program stored in at least one memory. In this case, the computer is provided by at least one memory and at least one processor core. The processor core is called CPU: Central Processing Unit, GPU: Graphics Processing Unit, RISC-CPU, etc. The memory is also called a storage medium. The memory is a non-transitional and substantial storage medium that non-transiently stores “program and/or data” that can be read by the processor. The storage medium is provided by a semiconductor memory, a magnetic disk, an optical disk, or the like. The program may be distributed alone or as a storage medium in which the program is stored. (ii) The hardware processor may be a hardware logic circuit. In this case, the computer is provided by a digital circuit including a number of programmed logic units (gate circuits). The digital circuit is also called a logic circuit array, for example, ASIC: Application-Specific Integrated Circuit, FPGA: Field Programmable Gate Array, SoC: System on a Chip, PGA: Programmable Gate Array, CPLD: Complex Programmable Logic Device. The digital circuit may comprise a memory storing programs and/or data. The computer may be provided by an analog circuit. A computer may be provided by a combination of a digital circuit and an analog circuit. (iii) The hardware processor may be a combination of the above (i) and the above (ii). (i) and (ii) are placed on different chips or on a common chip. In these cases, the part (ii) is also called an accelerator.

Next, with reference to FIG. 2 and FIG. 3, an operation principle of the lane changer warning system according to the embodiment is described.

FIG. 2 and FIG. 3 are schematic diagrams showing the operation principle of the lane changer warning system in the embodiment.

In FIG. 2 and FIG. 3, the own vehicle (sometimes referred to as “the vehicle VH0”) is the vehicle equipped with the lane changer warning system. The vehicle A is a first other vehicle which keeps the same traveling direction FWD as the own vehicle VH0 on the same lane as the own vehicle VH0 and is the nearest other vehicle ahead of the own vehicle VH0 on the same lane. The vehicle B is a second other vehicle which keeps the same traveling direction FWD as the own vehicle VH0 on a next lane to the own vehicle VH0 and is the nearest other vehicle ahead of the own vehicle VH0 on the next lane. The vehicle C is a third other vehicle keeps the same traveling direction FWD as the own vehicle VH0 at the next lane to the own vehicle VH0 (the same lane as the second other vehicle B) and is the nearest vehicle behind the own vehicle VH0 on the next lane.

As shown in FIG. 2, the coordinate system is set with the own vehicle VH0 as the origin (0,0), the traveling direction FWD as the Y axis positive direction, and the left to right as the X axis positive direction. Further, a hatching area in FIG. 3 is the same as the second other vehicle B.

The control device 20 handles a plurality of relative distances between the own vehicle VH0 and a plurality of other vehicles and, if necessary, between other vehicles. A distance between the own vehicle VH0 and the vehicle A in the Y axis direction is referred to as a relative distance S_{0A} (unit: meter). A distance between the own vehicle VH0 and the vehicle B in the Y axis direction is referred to as a relative distance S_{0B} (unit: meter). A distance between the own vehicle VH0 and the vehicle C in the Y axis direction is referred to as a relative distance S_{0C} (unit: meter). A distance between the vehicle B and the vehicle C in the Y axis direction is referred to as a relative distance SBC (unit: meter).

All the relative distances are distances to other vehicles detected by the detectors in real-time manner. All the relative distances are calculated by associated with mounting positions of the detectors and the length of the vehicle. The relative distance between the other vehicles may be calculated by the processor in the control device 20 in some cases.

The control device 20 handles a plurality of relative speeds between the own vehicle VH0 and a plurality of other vehicles and, if necessary, between other vehicles. A relative speed between the own vehicle VH0 and the vehicle A is referred to as a relative speed V_{0A} (unit: meter/second). A relative speed between the own vehicle VH0 and the vehicle B is referred to as a relative speed V_{0B} (unit: meter/second). A relative speed between the own vehicle VH0 and the vehicle C is referred to as a relative speed V_{0C} (unit: meter/second).

All relative speeds are calculated based on changes between two data frames outputted by the detector 10. All the relative speeds are calculated based on distance differences measured from both data frames in a earlier timing and a later timing, and time differences between both data frames.

The control device 20 handles a plurality of TTC (Time-To-Collision) between the own vehicle VH0 and a plurality of other vehicles and, if necessary, between other vehicles. A time remaining until a collision of two arbitrary vehicles, that is, a time required for a front end of a behind vehicle to reach a rear end position line of a preceding vehicle is referred to as TTC. A time required for collision between the own vehicle VH0 and the vehicle A is referred to as TTC_{0A} (unit: second). A time required for collision between the own vehicle VH0 and the vehicle B is referred to as TTC_{0B} (unit: second). A time required for collision between the own vehicle VH0 and the vehicle C is referred to as TTC_{0C} (unit: second). A time required for collision between the vehicle B and the vehicle C is referred to as TTC_{BC} (unit: second).

As will be described later, all the TTCs are calculated from relative distances and relative speeds. All the relative distances, relative speeds, and TTCs are stored in the memory by the processor, and renewed by the processor within the control unit 20, and the processor can refer to all the relative distances by accessing the memory.

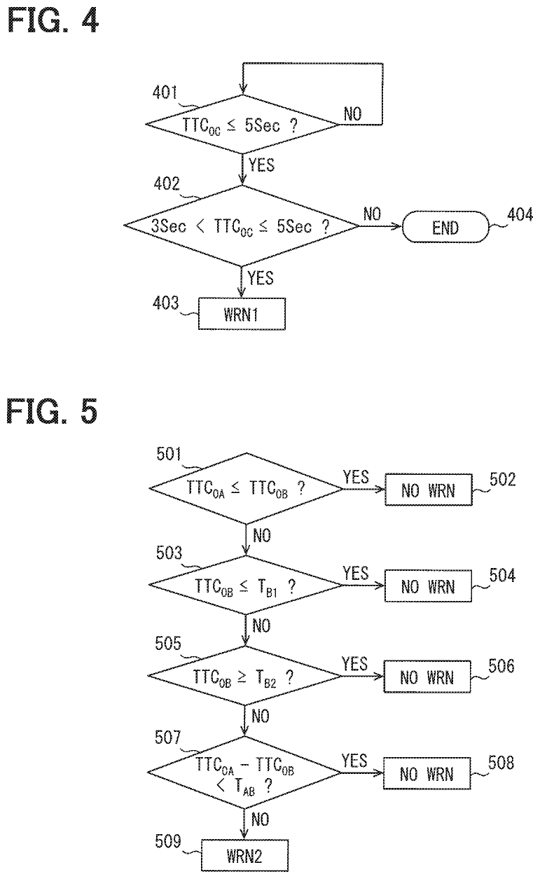

Subsequently, with reference to FIG. 4, process executed by the lane changer warning system in the embodiment when another vehicle traveling from behind rapidly approaches is described.

FIG. 4 is a flowchart showing a computing process executed by the lane changer warning system in the embodiment when the vehicle traveling from behind rapidly approaches.

As shown in FIG, 4, the process begins when the second detector 12 disposed on the rear of the vehicle VH0 detects and lock on the vehicle C. The process includes a calculating step of value of TTC_{0C} by the control device 20, and a determining step of whether a prior warning should be performed by the notification device 30 or not based on TTC_{0C} by the control device 20.

The control unit 20 suspends determination of a lane change, if TTC_{0C}>5 (seconds). The symbol “TTC_{0C}>5” means TTC_{0C} is greater than 5 seconds. The control unit 20 causes the notification device 30 to issue a warning that the other vehicle traveling from behind is rapidly approaching, if TTC_{0C} reaches TTC_{0C}=5 seconds. This warning is called a prior warning because it is 5 seconds before a possible collision.

If TTC_{0C}=5 (seconds), the control device 20 causes the notification device 30 to issue the prior warning of a rapid approach of the other vehicle traveling from behind.

If 3<TTC_{0C}<5 (seconds), the control device 20 causes the notification device 30 to give the prior warning of a rapid approach of the other vehicle traveling from behind. The symbol “TTC_{0C}<5” means TTC_{0C} is less than 5 seconds.

If TTC_{0C}=5 (seconds), the control device 20 causes the notification device 30 to issue the prior warning of a rapid approach of the other vehicle traveling from behind.

The notification device 30 gives the prior warning and presenting to the driver of the own vehicle about a rapid approach of the other vehicle traveling from behind, by using appropriate means such as sound, light, vibration, or the like. By doing this, it is possible to give information for appropriate maneuvers of the own vehicle.

The control unit 20 repeatedly calculates the relative acceleration of the vehicle A, the vehicle B, and the vehicle C which period in which TTC_{0C} is reduced from 5 seconds to 3 seconds.

When TTC_{0C} reaches to TTC_{0C}=3 (seconds), the control device 20 computes the positional relationship between the three vehicles, in an estimating manner, at a time of TTC_{0C}=0 (seconds), based on the positional relationship of the vehicle A, the vehicle B, the vehicle C, and the relative acceleration obtained by the repeated calculation. The control device 20 performs the lane change computation of the other vehicle traveling from behind based on the computed values above.

By executing step 401 by the control device 20, the system executes standby processing until TTC_{0C} becomes 5 seconds or less. By executing step 402 by the control device 20, step 403 is executed continuously for the period defined by T1<TTC_{0C}≤2, and the system continues to output the approach warning WRN 1. The symbol “TTC_{0C}T2” means “TTC_{0C} is less than or equal to T2. For example, T1 is 3 seconds and T2 is 5 seconds. By executing step 404 by the control device 20, the system stops the warning WRN1.

Subsequently, referring to FIG. 5, computing process for estimating the lane change of the other vehicle traveling from behind, performed by the lane changer warning system in the embodiment, is described.

FIG. 5 is a flowchart showing a lane change computing process of the other vehicle approaching from behind, performed by the lane changer warning system in the embodiment. By executing steps 501 to 509 by the control device 20, the system determines the possibility of lane change, and outputs a lane change warning WRN2 when the possibility of lane change exceeds a predetermined threshold value. In a preferred embodiment, the lane change warning WRN2 is different from the approach warning WRN1.

The condition of step 501 is a condition for determining a state in which the vehicle A and the vehicle B are in parallel or a state in which the vehicle B precedes the vehicle A, and if the condition is satisfied (YES), it is determined that no lane change is needed, therefore a non-warning (NO WRN) is determined in step 502. The condition of step 503 is a condition for determining a state in which the relative distance between the own vehicle VH0 and the vehicle B is too close, and if the condition is satisfied (YES), it is determined that no lane change is needed, therefore a non-warning (NO WRN) is determined in step 504. The condition of step 505 is a condition for determining a state in which the relative distance between the own vehicle VH0 and the vehicle B is too distanced, and if the condition is satisfied (YES), it is determined that no lane change is needed, therefore a non-warning (NO WRN) is determined in step 506. The condition of step 507 is a condition for determining a state in which the relative distance between the vehicle A and the vehicle B is too close, and if the condition is satisfied (YES), it is determined that no lane change is needed, therefore a non-warning (NO WRN) is determined in step 508. If negatively determined in all steps 501 to 507, the system outputs a lane changer warning WRN2.

First, the control unit 20 sets V as the relative speed, S as the relative distance to the own vehicle, and A as the relative acceleration. The control unit 20 also sets the relative speed and the relative acceleration of each of the vehicles identified at the beginning to zero.

The control unit 20 sets each initial value of the vehicle A as S_{0A}1, V_{0A}1, A_{A}1, sets each initial value of the vehicle B as S_{0B}1, V_{0B}1, A_{B}1, and sets each initial value of the vehicle C as S_{0C}1, V_{0C}1.

After a time difference T is elapsed, each initial value changes to the following value, respectively. Among them, T is a detection frequency of the detector, for example, is set to 50 ms.

Vehicle A:S_{0A}2

A_{A}2=(2×(S_{0A}2−S_{0A}1−V_{0A}1×T))/(T×T)

V_{0A}2=V_{0A}1+A_{A}2×T

TTC_{0A}=(SQRT(2×S_{0A}2×A_{A}2+V_{0A}2×V_{0A}2)−V_{0A}2)/A_{A}2

Vehicle B:S_{0B}2

A_{B}2=(2×(S_{0B}2−S_{0B}1−V_{0B}1×T))/(T×T)

V_{0B}2=V_{0B}1+A_{B}2×T

TTC_{0B}=(SQRT(2×S_{0B}2×A_{B}2+V_{0B}2×V_{0B}2)−V_{0B}2)/A_{B}2

Vehicle C:S_{0C}2

A_{C}2=(2×(S_{0C}1−S_{0C}2−V_{0C}1×T))/(T×T)

V_{0C}2=V_{0C}1+A_{C}2×T

TTC_{0C}=(SQRT(2×S_{0C}2×A_{C}2+V_{0C}2×V_{0C}2)−V_{0C}2)/A_{C}2

In other words, the control unit 20, in the process of the lane change of the other vehicle traveling from behind, determines by calculation whether TTC_{0C}=3 (seconds) or not, and repeatedly calculates TTC_{0C} after a time difference T has elapsed if it is not 3 (seconds). When TTC_{0C} actually reaches TTC_{0C}=3 (seconds), the control device 20 predicts, by computation, three numerical values predicted at TTC_{0C}=0 based on present situations. The three numerical values including TTC_{0A} between the own vehicle and the vehicle A, TTC_{0B} between the own vehicle and the vehicle B, and TTC_{AB} between the vehicle A and the vehicle B.

The calculation formulas of TTC_{0A} and TTC_{0B} are as described above. The calculation formula of TTC_{AB} is TTC_{AB}=TTC_{0A}−TTC_{0B}.

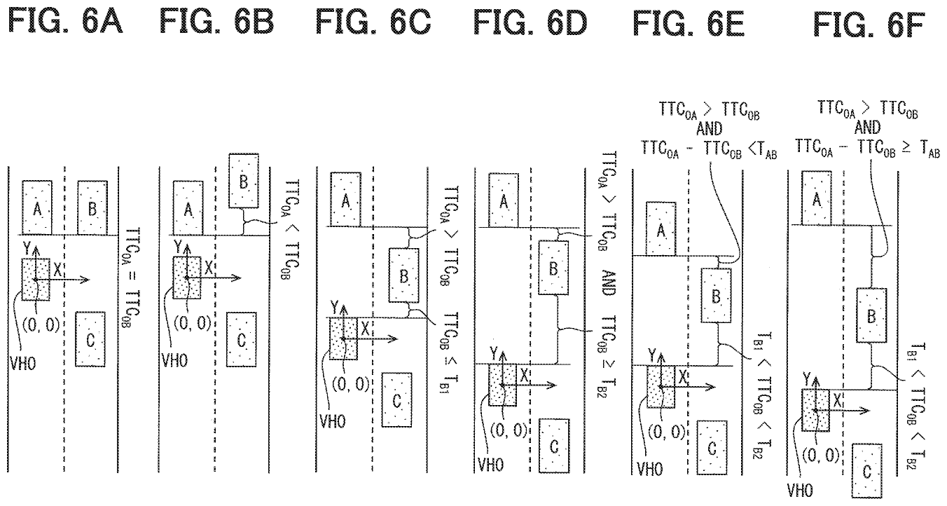

Subsequently, with reference to FIGS. 6A, 6B, 6C, 6D, 6E, and 6F, a method of determining a lane change of the other vehicle traveling from behind, executed by the lane changer warning system in the embodiment, is described. FIGS. 6A, 6B, 6C, 6D, 6E, and 6F show different situations, respectively.

As shown in FIGS. 6A, 6B, 6C, 6D, 6E, and 6F, in the case of TTC_{0A}=TTC_{0B}, the control device 20 determines that the vehicle B and the vehicle A are in parallel and that the vehicle C does not need to merge into the own vehicle lane.

FIG. 6A shows a case of TTC_{0A}=TTC_{0B}, and the control unit 20 determines that the vehicle B is in parallel with the vehicle A and that the vehicle C does not need to merge into the same lane in front of the own vehicle. FIG. 6B shows a case of TTC_{0A}<TTC_{0B}, the control device 20 determines that the vehicle B precedes the vehicle A and that the vehicle C does not need to merge into the same lane in front of the own vehicle.

FIG. 6C shows a case of TTC_{0A}>TTC_{0B} and TTC_{0B}≤T_{B1}, the control device 20 determines that the relative distance between the vehicle B and the own vehicle VH0 is short and the vehicle C does not have room to change the lane.

FIG. 6D shows a case of TTC_{0A}>TTC_{0B} and TTC_{0B}≥T_{B2}, the control device 20 determines that the relative distance between the vehicle B and the own vehicle VH0 is long and the vehicle C does not need to merge into the same lane in front of the own vehicle. The symbol “TTC_{0B}≥T_{B2}37 means “TTC_{0B} is greater than or equal to T_{B2}.

FIG. 6E shows a case of TTC_{0A}>TTC_{0B} and T_{B1}<TTC_{0B}<T_{B2}, the control device 20 determines that the relative distance between the vehicle B and the own vehicle is a permissible range for a lane change, and is in a range of the vehicle C may try a lane change. However, FIG. 6E shows a case of TTC_{0A}−TTC_{0B}<T_{AB}, the control device 20 determines that the relative distance between the vehicle A and the vehicle B is short and there is no need to change the lane.

FIG. 6F shows a case of TTC_{0A}>TTC_{0B} and T_{B1} <TTC_{0B}<T_{B2}, the control device 20 determines that the relative distance between the vehicle B and the own vehicle is a permissible range for a lane change, and is in a range of the vehicle C may try a lane change. In addition, FIG. 6F shows a case of TTC_{0A}−TTC_{0B}≥T_{AB}; and the control device 20 determines that the relative distance between the vehicle A and the vehicle B is relatively far and is suitable for a lane change. In the case of FIG. 6F, the control device 20 determines that the vehicle C may try to change the lane, and let the notification device 30 to warn, by issuing the warning WRN2, to the driver of the high possibility of attempt of a lane change of the vehicle C traveling from behind in advance. The notification device 30 gives an advance warning and presentation of the lane change of the vehicle C traveling from behind to the driver of the own vehicle by suitable means such as sound, light, vibration, or the like.

Since the numerical values of T_{B1}, T_{B2} and T_{AB} are important thresholds, they are set separately. For example, the threshold value T_{B1} is set within a range of 3 to 7 seconds, the threshold value T_{B2} is set within a range of 6 to 10 seconds, the threshold value T_{AB} is set with in a range of 1 to 4 seconds.

The vehicle A may be referred to a first vehicle, the vehicle B may be referred to as a second vehicle, and the vehicle C may be referred to as a third vehicle.

This disclosure includes the following inventive concepts. (1) A system of warning a lane changer, comprising: a detector which is disposed on an own vehicle, and measures relative distances between the own vehicle and other vehicles around the own vehicle; and a control device which computes, by at least one processor, a lane change of another vehicle traveling from behind. (2) The system in (1), wherein the control device computes, by at least one processor, a time required for a possible collision between the own vehicle and other vehicles, the other vehicles including a first vehicle; a second vehicle, and a third vehicle, the first vehicle keeping the same traveling direction as the own vehicle on the same lane as the own vehicle and being the nearest vehicle ahead of the own vehicle, the second vehicle keeping the same traveling direction as the own vehicle on a next lane to the own vehicle and being the nearest vehicle ahead of the own vehicle, the third vehicle keeping the same traveling direction as the own vehicle on the next lane and being the nearest vehicle ahead of the own vehicle; and wherein the control device assumes a time required for a possible collision between the own vehicle and the third vehicle as TTC_{0C}, and computes the lane change of the other vehicle traveling from behind when TTC_{0C}=T1, and wherein T1 is a predetermined value.

(3) The system in (2), wherein the control device assumes a time required for a possible collision between the own vehicle and the first vehicle as TTC_{0A}, and assumes a time required for a possible collision between the own vehicle and the second vehicle as TTC_{0B}, and wherein the control device computes, in an estimating manner, values of TTC_{0A} and TTC_{0B} at TTC_{0C}=0, when TTC_{0C} actually reaches TTC_{0C}=T1, and wherein the control device determines, by computing, that the third vehicle is about a lane change, when TTC_{0A} and TTC_{0B} at TTC_{0C}=0 satisfy TTC_{0A}>TTC_{0B}, T_{B1}<TTC_{0B}<T_{B2}, and TTC_{0A}−TTC_{0B}≥T_{AB}, and wherein T_{B1}, T_{B2}, T_{AB} are threshold values, and wherein T_{B2}>T_{B1}. (4) The system in (3), wherein the control device cumulatively calculates relative accelerations of the first vehicle, the second vehicle, and the third vehicle when T1<TTC_{0C}≤T2.

(5) The system in any one of (1) to (4), further comprises; a notification device which issues warning of the lane change of the other vehicle traveling from behind in a situation where the computation result of the control device shows the lane change. (6) The system in (4), wherein T1 is 3 seconds and T2 is 5 seconds. (7) The system in (3), wherein the threshold value T_{B1} is set within a range of 3 to 7 seconds, the threshold value T_{B2} is set within a range of 6 to 10 seconds, the threshold value T_{AB} is set with in a range of 1 to 4 seconds.

(8) A method of warning a lane changer, comprising the steps of: detecting, by at least one processor, relative distances between an own vehicle and other vehicles around the own vehicle, by using a detector disposed on the own vehicle; and computing a lane change of the other vehicle traveling from behind, by using a control device with at least one processor, based on data detected in the detecting step. (9) The method in (8), wherein the computing step includes computing a time required for a possible collision between the own vehicle and other vehicles, the other vehicles including a first vehicle, a second vehicle, and a third vehicle, the first vehicle keeping the same traveling direction as the own vehicle on the same lane as the own vehicle and being the nearest vehicle ahead of the own vehicle, the second vehicle keeping the same traveling direction as the own vehicle on a next lane to the own vehicle and being the nearest vehicle ahead of the own vehicle, the third vehicle keeping the same traveling direction as the own vehicle on the next lane and being the nearest vehicle ahead of the own vehicle, and wherein the computing step includes assuming a time required for a possible collision between the own vehicle and the third vehicle as TTC_{0C}, and computing the lane change of the other vehicle traveling from behind when TTC_{0C}=T1, and wherein T1 is a predetermined value.

(10) The method in (9), wherein the computing step includes assuming a time required for a possible collision between the own vehicle and the first vehicle as TTC_{0A}, and assuming a time required for a possible collision between the own vehicle and the second vehicle as TTC_{0B}, and wherein the computing step computes, in an estimating manner, values of TTC_{0A} and TTC_{0B} at TTC_{0C}=0, when TTC_{0C} actually reaches TTC_{0C}=T1, and wherein the computing step includes determining, by computing, that the third vehicle is about a lane change, when TTC_{0A} and TTC_{0B} at TTC_{0C}=0 satisfy TTC_{0A}>TTC_{0B}, T_{B1}<TTC_{0B}<T_{B2}, and TTC_{0A}−TTC_{0B}≥T_{AB}, and wherein T_{B1}, T_{B2}, T_{AB} are threshold values, and wherein T_{B2}>T_{B1}.

(11) The method in (10), wherein the computing step includes cumulatively calculating relative accelerations of the first vehicle, the second vehicle, and the third vehicle when T1<TTC_{0C}<T2. (12) The method in any one of (8) to (11), further comprising the steps of notifying warning of the lane change of the other vehicle traveling from behind by using a notification device in a situation where the computation result of the computing step shows the lane change. (13) The method in (11), wherein T1 is 3 seconds and T2 is 5 seconds. (14) The method in (10), wherein the threshold value T_{B1} is set within a range of 3 to 7 seconds, the threshold value T_{B2} is set within a range of 6 to 10 seconds, the threshold value T_{AB} is set with in a range of 1 to 4 seconds.

There are safe driving assistance systems. Regarding a merging vehicle determination function, there are functions, one warns merging maneuvers of another vehicle on a next lane try to merge into a lane in which an own vehicle is traveling, another one adjusts an inter-vehicle room in combination with ACC (Adaptive Cruise Control). However, there is no determination function about a merging vehicle approaching from behind. This disclosure provides a lane changer warning system and a lane changer warning method.

As described above, based on the lane changer warning system and the lane changer warning method of the present disclosure, it is possible to detect and notify the intention of the other vehicle traveling from behind to merge into a own vehicle lane. In other words, it is possible to determine whether or not the vehicle traveling from behind has the intention and necessity of a lane change by associating with the vehicle condition around the own vehicle and the road condition. Also, it is possible to monitor a distance between a first vehicle in the same lane and the own vehicle, a distance between a second vehicle in an adjacent lane and the own vehicle, and a distance between a third vehicle on the adjacent lane and the own vehicle in a real time manner. The system and method determines, by computing, whether or not there is intention of lane change and room for lane change, at a stage when the third vehicle is about to overtake the own vehicle.

Thus, the lane changer warning system and the lane changer warning method based on this disclosure promptly notify the driver that there is a potential lane changer.

The lane changer warning system and the lane changer warning method based on the present disclosure can predict the travel locus of the third vehicle through real time detection of the detector and analysis of changes in other vehicles and road environments. According to this disclosure, it is possible to determine a lane change vehicle which is intentionally maneuvered to merge in front of the own vehicle into the same lane as the own vehicle travels. In addition, it warns and presents the driver of the own vehicle with appropriate means, such as sound, light, vibration, etc.

Although this disclosure has been described illustratively for the disclosure in conjunction with the drawings, as noted above, it is evident that the specific realization of this disclosure is not limited by the above embodiments. Other advantages and modifications can be easily conceived by those skilled in the art. Thus, from a broader aspect, this disclosure is not limited to the specific details and representative embodiments shown and described herein. Accordingly, various modifications can be made on the premise that they do not depart from the spirit or scope of the concept of the whole disclosure limited by the scope of the attached claims and their equivalents.

For example, in the above-described embodiment, the relative distances between the own vehicle and surrounding other vehicles are detected by the detector mounted on the own vehicle. Alternatively, it is also possible to detect the relative distances between the own vehicle and surrounding other vehicles by using a highly accurate satellite map data and a satellite positioning system.

In the above embodiment, whether or not there is an intention of lane change in the vehicle C is determined based on the time parameters TTC_{0A}, TTC_{0B}, and TTC_{0C} and the relationship between the numerical values of them. However, as described in the specification, all TTCs are calculated based on relative distances and relative speeds. Therefore, it is completely predictable for those skilled in the art that whether or not there is an intention to change a lane of the vehicle C can also be determined based on other parameters, for example, S_{0A}, S_{0B}, and S_{0C}.

As an arithmetic control method in such a situation, for example, when the relative distance S_{0C} in the Y-axis direction between the own vehicle and the vehicle C is a predetermined value, the control device performs the lane change calculation control of the vehicle traveling from behind, estimates S_{0A} and S_{0B} when S_{0C}=0, and determines that the vehicle C is about to change lanes when S_{0A} and S_{0B} satisfy a certain positional relationship, and then performs the lane change warning of the vehicle traveling from behind by using the notification device.

What is claimed is:

1. A system of warning a lane changer, comprising:
a detector which is disposed on an own vehicle, and measures relative distances between the own vehicle and other vehicles around the own vehicle; and
a control device which computes, by at least one processor, a lane change of another vehicle traveling from behind.

2. The system claimed in claim 1, wherein
the control device computes, by at least one processor, a time required for a possible collision between the own vehicle and other vehicles,
the other vehicles including a first vehicle, a second vehicle, and a third vehicle,
the first vehicle keeping the same traveling direction as the own vehicle on the same lane as the own vehicle and being the nearest vehicle ahead of the own vehicle,
the second vehicle keeping the same traveling direction as the own vehicle on a next lane to the own vehicle and being the nearest vehicle ahead of the own vehicle,
the third vehicle keeping the same traveling direction as the own vehicle on the next lane and being the nearest vehicle ahead of the own vehicle, and wherein
the control device assumes a time required for a possible collision between the own vehicle and the third vehicle as TTC_{0C}, and computes the lane change of the other vehicle traveling from behind when TTC_{0C}=T1, and wherein T1 is a predetermined value.

3. The system claimed in claim 2, wherein
the control device assumes a time required for a possible collision between the own vehicle and the first vehicle as TTC_{0A}, and assumes a time required for a possible collision between the own vehicle and the second vehicle as TTC_{0B}, and wherein
the control device computes, in an estimating manner, values of TTC_{0A} and TTC_{0B} at TTC_{0C}=0, when TTC_{0C} actually reaches TTC_{0C}=T1, and wherein
the control device determines, by computing, that the third vehicle is about a lane change, when TTC_{0A} and TTC_{0B} at TTC_{0C}=0 satisfy TTC_{0A}>TTC_{0B}, T_{B1}<TTC_{0B}<T_{B2}, and TTC_{0A}−TTC_{0B}≥T_{AB}, and wherein T_{B1}, T_{B2}, T_{AB} are threshold values, and wherein T_{B2}>T_{B1}.

4. The system claimed in claim 3, wherein
the control device cumulatively calculates relative accelerations of the first vehicle, the second vehicle, and the third vehicle when T1<TTC_{0C}≤T2.

5. The system claimed in claim 1, further comprising:
a notification device which issues warning of the lane change of the other vehicle traveling from behind in a situation where the computation result of the control device shows the lane change.

6. The system claimed in claim 4, wherein
T1 is 3 seconds and T2 is 5 seconds.

7. The system claimed in claim 3, wherein
the threshold value T_{B1} is set within a range of 3 to 7 seconds, the threshold value T_{B2} is set within a range of 6 to 10 seconds, the threshold value T_{AB} is set with in a range of 1 to 4 seconds.

8. A method of warning a lane changer, comprising the steps of:
detecting, by at least one processor, relative distances between an own vehicle and other vehicles around the own vehicle, by using a detector disposed on the own vehicle; and
computing a lane change of the other vehicle traveling from behind, by using a control device with at least one processor, based on data detected in the detecting step.

9. The method claimed in claim 8, wherein
the computing step includes computing a time required for a possible collision between the own vehicle and other vehicles,
the other vehicles including a first vehicle, a second vehicle, and a third vehicle,
the first vehicle keeping the same traveling direction as the own vehicle on the same lane as the own vehicle and being the nearest vehicle ahead of the own vehicle,
the second vehicle keeping the same traveling direction as the own vehicle on a next lane to the own vehicle and being the nearest vehicle ahead of the own vehicle,
the third vehicle keeping the same traveling direction as the own vehicle on the next lane and being the nearest vehicle ahead of the own vehicle, and wherein
the computing step includes assuming a time required for a possible collision between the own vehicle and the third vehicle as TTC_{0C}, and computing the lane change of the other vehicle traveling from behind when TTC_{0C}=T1, and wherein T1 is a predetermined value.

10. The method claimed in claim 9, wherein
the computing step includes assuming a time required for a possible collision between the own vehicle and the first vehicle as TTC_{0A}, and assuming a time required for a possible collision between the own vehicle and the second vehicle as TTC_{0B}, and wherein
the computing step computes, in an estimating manner, values of TTC_{0A} and TTC_{0B} at TTC_{0C}=0, when TTC_{0C} actually reaches TTC_{0C}=T1, and wherein
the computing step includes determining, by computing, that the third vehicle is about a lane change, when TTC_{0A} and TTC_{0B} at TTC_{0C}=0 satisfy TTC_{0A}>TTC_{0B}, T_{B1}<TTC_{0B}<T_{B2}, and TTC_{0A}−TTC_{0B}≥T_{AB}, and wherein T_{B1}, T_{B2}, T_{AB} are threshold values, and wherein T_{B2}>T_{B1}.

11. The method claimed in claim 10, wherein
the computing step includes cumulatively calculating relative accelerations of the first vehicle, the second vehicle, and the third vehicle when T1<TTC_{0C}≤T2.

12. The method claimed in claim 8, further comprising the steps of
notifying warning of the lane change of the other vehicle traveling from behind by using a notification device in a situation where the computation result of the computing step shows the lane change.

13. The method claimed in claim 11, wherein
T1 is 3 seconds and T2 is 5 seconds.

14. The method claimed in claim 10, wherein
the threshold value T_{B1} is set within a range of 3 to 7 seconds, the threshold value T_{B2} is set within a range of 6 to 10 seconds, the threshold value T_{AB} is set with in a range of 1 to 4 seconds.
